(19) United States
(12) Patent Application Publication
(10) Pub. No.: US 2011/0314382 A1
(43) Pub. Date: Dec. 22, 2011

(54) SYSTEMS OF COMPUTERIZED AGENTS AND USER-DIRECTED SEMANTIC NETWORKING

(75) Inventor: Peter Sweeney, Kitchener (CA)

(73) Assignee: Primal Fusion Inc., Waterloo (CA)

(21) Appl. No.: 13/164,732

(22) Filed: Jun. 20, 2011

Related U.S. Application Data
(60) Provisional application No. 61/357,509, filed on Jun. 22, 2010.

(51) Int. Cl. G06F 15/16; G06F 3/01

(52) U.S. Cl. 715/738; 709/202

(57) ABSTRACT

A system, method and computer program product in which semi-autonomous agents interact with a semantic network. In a basic embodiment of the system, a data structure providing a semantic network is provided in a non-transitory, computer-readable medium within a computer network. A plurality of computer-implemented agents are deployed within the computer network and interactive with the semantic network. A user interface is provided and configured to permit a user to create and/or modify the semantic network. The agents are configured to read and modify the semantic network without receiving explicit instructions from a user after their initial deployment, whereby the agents operate as assistants to support the user's use of the network.

### CROSS-REFERENCE TO RELATED APPLICATIONS

This application claims priority to U.S. Provisional Application No. 61/357,266 filed on Jun. 22, 2010 and titled “Systems and Methods for Analyzing and Synthesizing Complex Knowledge Representations,” which is incorporated by reference herein.

### FIELD OF INVENTION

The teachings disclosed herein relate to deployment, in an information system environment incorporating one or more user-directed semantic networks representing knowledge domains, of multiple computer-implemented software agents capable of autonomous action and of interaction with such networks to perform a variety of tasks. In so doing, an autonomous or intelligent distributed information processing system respective of user knowledge is formed, constituting another aspect of the teachings presented herein.

### BACKGROUND

The Internet is a global system of interconnected computer networks that store a vast array of information. The World Wide Web (WWW) is an information sharing model built on top of the Internet, in which a system of interlinked hypertext documents are accessed using particular protocols (e.g., the Hypertext Transfer Protocol and its variants).

Because of the enormous volume of information available via the WWW and the Internet, and because the available information is distributed across an enormous number of independently owned and operated networks and servers, locating and acting upon desired content on the WWW and the Internet presents challenges. Similar challenges exist when the information of interest is distributed across large private networks, as well.

Various tools such as search engines have been developed to aid users in locating desired content on the Internet and other networks, and software agents have been developed to effectuate some desired user actions relative to such content.

A search engine is a computer program that receives a search query from a user (e.g., in the form of a set of keywords) indicative of content desired by the user, and returns information and/or hyperlinks to information that the search engine determines to be relevant to the user's search query.

Search engines typically work by retrieving a large amount of material satisfying the search criteria specified in the search query (either exactly or within some boundaries), such as a large number of WWW web pages and/or other content, using a computer program called a web crawler that traverses the WWW in an automated fashion (e.g., following every hyperlink that it comes across in each web page that it finds). The retrieved web pages and/or content are analyzed and information about the web pages or content is stored in an index. When a user issues a search query to the search engine, the search engine uses the index to identify the web pages and/or content that it determines to best match the user's search query and returns a list of results with the best-matching web pages and/or content. Frequently, this list is in the form of one or more web pages that include a set of hyperlinks to the web pages and/or content determined to best match the user's query.

Software agents have been developed as proxies for their users, to perform various tasks such as facilitating the execution of user-desired tasks relative to network information. In the field of computer science, software agents are software entities which execute on processors to perform a variety of functions, typically on behalf of users who have deployed them. More precisely, the term “agent” is applied to a software entity that is capable of acting with a certain degree of autonomy (agents have capabilities of task selection, prioritization, goal-directed behavior, decision-making without significant human intervention) in order to accomplish tasks on behalf of a user. While software (i.e., computer program code) by itself is no more than inert information, we assume when referring to a software agent that it is code actively executing on a processor for only then can it be a functional element. Additionally, agents commonly exhibit attributes such as persistence (code is not executed on demand but runs continuously and decides for itself when it should perform some activity); social ability (agents are able to engage other components through communication and they may therefore, effectively, collaborate (i.e., act in concert) on a task); and reactivity (agents perceive the context or environment in which they operate and react to it appropriately).

However, software agents require knowledge models that provide a domain from which to operate. Conventional agents will often work from a single key word or phrase provided by the user. Further, traditional agents work in isolation and do not evolve in their function. Thus, making an agent that meets the multi-faceted needs of a user and, adapts to meet the changing needs of the user, requires the construction and maintenance of a knowledge model that is expensive and difficult to scale. The teachings disclosed herein are directed at least partly towards better addressing user needs.

### SUMMARY

For purposes of the current discourse, examples of the kind of functions which may be performed by software agents include at least information harvesting (harvesting agents), deep data analytical mining (data mining agents), information retrieval (search agents), social networking and other personal tasks (social agents, also called personal agents or user agents), e-commerce tasks (shopping agents, also called shopping bots or buyer agents), and monitoring and surveillance.

Buyer agents “travel” or “crawl” around a network (e.g., the global internet) (i.e., they access different network addresses) retrieving information about goods and services, such as the prices different vendors are charging. These agents, also known as ‘shopping bots’, work efficiently for commodity products such as CDs, books, and electronic components.

User agents, or personal agents, are intelligent agents that, on a user's behalf, take action other than one assigned to other types of agents. In this category belong those intelligent agents that already perform, or will shortly perform, tasks such as checking e-mail and sorting it according to the user's order of preference and alerting the user when important emails arrive.

Harvesting agents may extract surface-level information, such as snippets of data or chunks of content.

Data mining agents allow pattern extraction by performing deep analytics on large data sets.

Search agents may find information on the subject of a user's choice and monitor for changes in the status of certain information.

This list of agent types and functions is not intended to be exhaustive and is only exemplary, of course.

The use of agents is increasing in number and type, to provide expanding automated functionality to a growing number of users. To effectuate such operation, users must be able to interact with agents and agents must be able to interact with the information content of the network. The user-agent interaction must occur notwithstanding the goal of agent autonomy; ultimately, the tasks are directed to helping users become more productive.

Additionally, software agents need to work together efficiently within such environments. A shopping agent, for example, may be designed and configured to use the results of a search performed by a search agent. Therefore, they must share semantics of their data elements. This can be done by having computer systems publish their metadata (defining data relationships and qualities) using shared ontologies for representing knowledge. Within such a framework, an agent uses its access methods (which need not be the same from one agent to the next) to go into local and remote databases to forage for content. These access methods may include, but are not limited to, setting up news stream delivery to the agent, or retrieval from bulletin boards, or using a so-called spider program to traverse the Web. The content that is retrieved in this way may already be partially filtered—by the selection of the newsfeed or the databases that are searched. The agent next may use its detailed searching or language-processing machinery to extract keywords or signatures from the body of the content that has been received or retrieved. This abstracted content (or event) is then passed to the agent's reasoning or inferencing machinery in order to decide what to do with the new content. This process combines the event content with the rule-based or knowledge content provided by the user. If this process finds a good hit or match in the new content, the agent may use another piece of its (i.e., code base) machinery to do a more detailed search or analysis on the content. Finally, the agent may decide to take an action based on the new content; for example, to notify the user that an important event has occurred. This action may be verified by a security function and then given the authority of the user. The agent makes use of a user-access method to deliver that message to the user. If the user confirms that the event is important by acting quickly on the notification, the agent may also employ its learning machinery to increase its weighting for this kind of event.

Software agents thus may offer various benefits to their end users by automating complex or repetitive tasks. However, there are several potential limitations and impacts of this technology that need to be considered. For example, to provide an agent-based system capable of many different tasks for many different people, a great deal of effort must be directed to modeling the knowledge domain within which the agents and people will interact. For example, to provide an effective agent-based system for making restaurant reservations, knowledge of restaurants and how to book reservations must be modeled in the system. This knowledge requirement also compounds the complexity and sophisticated capabilities needed in the agents, reflected in the term, “intelligent” agents. This requirement for intelligent agents slows the development and proliferation of agent-based systems, and increases their development cost and the complexity of agents. Thus, the available tools used for manufacturing agents seem to be producing ever more capable, but ever more complex agents. As agents get more complicated, the task of assuring their correct functioning under all circumstances becomes more challenging and costly.

Further, agents rarely have a direct or detailed “insight” into the needs and requirements of the people they are supporting. That is, while they may be designed for autonomy, their range of potential action is limited to that which is pre-programmed, they lack self-awareness and awareness of the objectives, needs and requirements of their users. Thus, as those needs and requirements change, users must interact with their agents to make known these changes by revising agent programming, requiring both complicated interfaces and user attention. As a result, instead of the system adapting to the user, if efficiency is to be maintained, the user must effectuate the adaptation. It may be desirable, instead, for the behavior of an agent to adapt itself to a user's changed needs by responding to changes in the user's behavior manifesting changes in the user's requirements, without explicit user instruction.

This is challenging, but consistent with an important design objective for agents—that they be able to act autonomously—i.e., without significant human intervention. Designing to this objective, though, is somewhat inconsistent with the notion of agents that are responsive to user intentions. There is therefore a need for a middle ground between manual human activities fully autonomous software agents, agents that are able to respond to their users without direct or explicit user direction.

Of course, the ability of agents to process information and derive meaningful results therefrom is highly dependent on the knowledge models upon which the agents operate (as both input and output). In general, the knowledge upon which such agents act is an ontology, i.e. a formal, structured representation of the knowledge embodied by a set of concepts within a particular domain and the relationships between those concepts. An ontology allows agents to operate logically on the properties of that domain—i.e., to “reason,” and may be used to describe the domain itself. Thus, an ontology provides a shared vocabulary, which can be used to model a domain—that is, the type of objects and/or concepts that exist, and their properties and relations. Within computer science, an ontology is a model for describing the world (i.e., the domain) that consists of a set of types, properties, and relationship types. Exactly what is modeled varies. There is also generally an expectation that there be a close resemblance between the real world and the features of the model in an ontology.

Contemporary ontologies share many structural similarities, regardless of the language in which they are expressed. As mentioned above, most ontologies describe individuals (instances), classes (concepts), attributes, and relations. There exist many tools today for building ontologies and it is not necessary for purposes of this discussion to single out any of them. Some employ standards-based ontology languages; some employ proprietary ontology languages. Those skilled in the art will be able to select an appropriate ontology building tool for use in practice of the inventive embodiments and concepts described herein.

Since domain ontologies represent concepts in very specific and often varied ways, they are often incompatible. A domain ontology (or domain-specific ontology) models a specific domain, or part of the world. It represents the particular meanings of terms as they apply to that domain. For example the word “card” has many different meanings. An ontology about the domain of poker would model the “playing card” meaning of the word, while an ontology about the domain of computer hardware would model the “punched card” and “video card” meanings. Similarly, the word “green” has different meanings, not only within different domains, but also from the context of usage. It might be modeled primarily as a color in a domain about fashion, while a domain about environmental issues might model it as having low environmental impact or using little energy.” A domain about people might model “green” as a surname or as a synonym to “inexperienced.” So the same term might even be modeled as different parts of speech and as having different meanings in the same domain, depending on the part of speech. In other words, a useful ontology must, relative to the domain, disambiguate the meanings attributable to terms so that, among other things, the actions of multiple agents relative to the ontology will be consistent, meaningful and useful.

Changing the way computerized software agents, domain ontologies and users interact can lead to several advantages. Among them, agents can be less complex, allowing complex behaviors instead to emerge from the indirect interactions of multiple simpler agents via changes to the user-directed knowledge model on which they operate. Moreover, users can more intuitively and more simply express their intentions by operating directly on the data in the knowledge model, as well, without having to re-configure or reprogram or re-task their agents.

Accordingly, a first aspect of the invention is a computer system including, in a non-transitory, computer-readable medium within a computer network, a data structure providing a semantic network. (This medium need not be localized and may be distributed, even involving multiple types of data storage.) A plurality of computer-implemented agents are deployed within said computer network and are interactive with the semantic network. The system further includes a user interface configured to permit a user to at least modify the semantic network. The agents are configured to read and modify the semantic network without receiving substantial explicit instructions from a user. Modifying the semantic network may include changing, editing, altering, augmenting, adding to or deleting from the semantic network. In some embodiments, the agents may include at least one of a harvesting agent, data mining agent, search agent, connecting agent, personal agent or shopping agent, among other possibilities. The autonomous nature of agent operations allows at least two of the plurality of agents to collaborate with each other, either explicitly through direct communication or implicitly through indirect communication effected by interaction through the semantic network. In some embodiments, at least one of the agents is configured to synthesize a concept to the semantic network, and add a node, or to change a value or delete a node or edge of the network from the data structure. In some embodiments, at least a second agent of the plurality of agents acts upon or in response to the changed value, addition or deletion of the entry.

According to a second aspect, a method comprises providing a semantic network within a computer network; providing a plurality of computer-implemented agents deployed within said computer network and interactive with the semantic network, the agents being configured to read, edit or otherwise influence the semantic network without receiving explicit instructions from a user; and providing a user interface configured to permit a user to edit the semantic network.

A further aspect is a method to decouple user and agent actions with respect to a semantic network. An information exchange platform is provided, comprising an editable semantic network instantiated in a non-transitory, computer-readable medium within a computer network. A plurality of computer-implemented agents are deployed within the computer network and interactive with the semantic network, the agents being configured to autonomously read and modify the semantic network. A provided user interface is configured to permit a user to at least receive reports regarding or to modify the semantic network.

According to still another aspect, a method is show, comprising making available to users of a computer network a semantic network building took and a plurality of computer-implemented agents deployable within said computer network and interactive with a semantic network constructed by the user with the tool, the agents being configured to read and modify the semantic network without receiving explicit instructions from a user. In some embodiments, the method further includes providing a user interface configured to permit a user to modify the semantic network.

According to yet still another aspect, a non-transitory computer readable storage medium is disclosed that stores processor executable instructions including software modules that may perform any of numerous tasks in accordance with some embodiments. For example, the instructions include a semantic network module configured to provide a data structure that includes a semantic network. The instructions also include an agent-interface module configured to allow interaction between a plurality of computer-implemented agents and the semantic network, and a user-editing module configured to permit, through a user interface, modification of the semantic network by a user.

### BRIEF DESCRIPTION OF DRAWINGS

In the drawings,

FIG. 1 is a block diagram representing an embodiment of some aspects of the invention;

FIG. 2 is a block diagram further illustrating an agent ecosystem according to some embodiments;

FIG. 3 is a diagrammatic illustration of an exemplary operation of a user editing a semantic network (e.g., an ontology or knowledge model) according to some embodiments;

FIG. 4 is an illustration of activities resulting from an ecosystem of agents; and

FIG. 5 is an illustration of a system architecture within which agents can be deployed.

### DETAILED DESCRIPTION

The methods, systems and products disclosed herein can be implemented using existing agent creation tools and any of various available techniques for knowledge representation, including ontology languages and ontology building tools, as well as future agent and knowledge representation tools. While it is not intended that the claimed invention be limited to specific knowledge representations, a preferred form is the type of ontology referred to as a semantic network. Semantic networks are explained in many sources, noteworthy among them being U.S. patent application Ser. No. 12/671,846, titled Method, System, And Computer Program For User-Driven Dynamic Generation Of Semantic Networks And Media Synthesis by Peter Sweeney et al, which is hereby incorporated by reference.

Semantic networks may be used as forms of knowledge representation. A semantic network may be represented as a directed graph consisting of vertices that represent concepts, and edges that represent semantic relations between the concepts, and encoded in a corresponding data structure in a computer-readable storage medium.

Semantic networks have a broad utility as a form of knowledge representation. As machine-readable data, they can support a number of advanced technologies, such as artificial intelligence, software automation and agents, expert systems, and knowledge management. Additionally, they can be transformed into various forms of media (i.e. other knowledge representations). In other words, the synthesis or creation of semantic networks can support the synthesis of a broad swath of media to extract additional value from the semantic network.

Thought networking, and semantic synthesis as made available, for example, by Primal Fusion, Inc. of Waterloo, ON, Canada, www.primal.com, provides a good method and system for generating user-directed semantic networks that represent a user's knowledge relative to a domain. Semantic synthesis constructs semantic networks that encode such thoughts and intentions of the user. Encoded as data in organized data structures, these thoughts and intentions are then available for computing purposes, for example, in support of agent-based systems.

A thought network, also known as a knowledge network, refers to a type of user-directed semantic network (to contrast with semantic networks that are composed by the producers of information as opposed to the end-users). It represents users' thoughts as interconnected concepts. This lattice-like structure is how thoughts are represented as data and made concrete. Ideally, however, users will remain unaware of this deep structure as they interact with their thought networks.

As stated above, thought networking has previously been employed to capture users' thoughts and intentions. It is possible, however, also to use thought networking to generate semantic networks that may be used as input to software agents. In turn, those agents may output changes to those (or additional) semantic networks. If a domain knowledge base is captured in a semantic network and both users and agents interact with the semantic network, rather than interacting directly with each other, it is possible to dispense with all or most of the need for a user to interact directly with its agents. Agents can be simplified by reducing their functionality, by eliminating a direct user interface, by reducing their need to duplicate functions, and by allowing behavior to emerge from the collective actions of a number of agents of different types. Agent functionality may even be reduced to a single function, provided a suitable collection of agents of differing functions is made available, to accomplish a desired set of tasks.

The collection of interacting agents or groups of agents is referred to as an “agent ecosystem.” Enabling people to affect changes directly to the semantic networking environment lowers the costs and complexity associated with individual software agents and software agent ecosystem development.

One might say that people (users) participate in such a system or systems by constructing landscapes of their thoughts (in semantic data) while relatively simple agents (possibly large numbers of them) can work over that landscape of user intelligence to get work done. The agents may be analogous to ants roaming over the landscapes, cooperating with each other within the environment imposed by the architects of the landscapes (that is, the users). Further, if users and agents both can act by altering the landscape, they can influence the operation of the agents without the users having to directly control their agents. Decoupling the user interactions from the agent interactions provides for new applications/design patterns. Different types of agents (for example, search agents plus harvesting agents) may collaborate to accomplish tasks of emergent complexity. That is, one type of agent may call upon other types of agents to take actions, and the sophistication of the resultant action might eclipse, or go beyond to achieve more than the capabilities of each individual agent. For example, one agent may harvest information and decorate the semantic network with this information. A second agent, operating autonomously, may simply compose a report of changes to the semantic network. Each agent may respond to the environment of the knowledge landscape without requiring any understanding of how the landscape is composed or the higher-order behaviors that may emerge as agents and users interaction with the knowledge landscape.

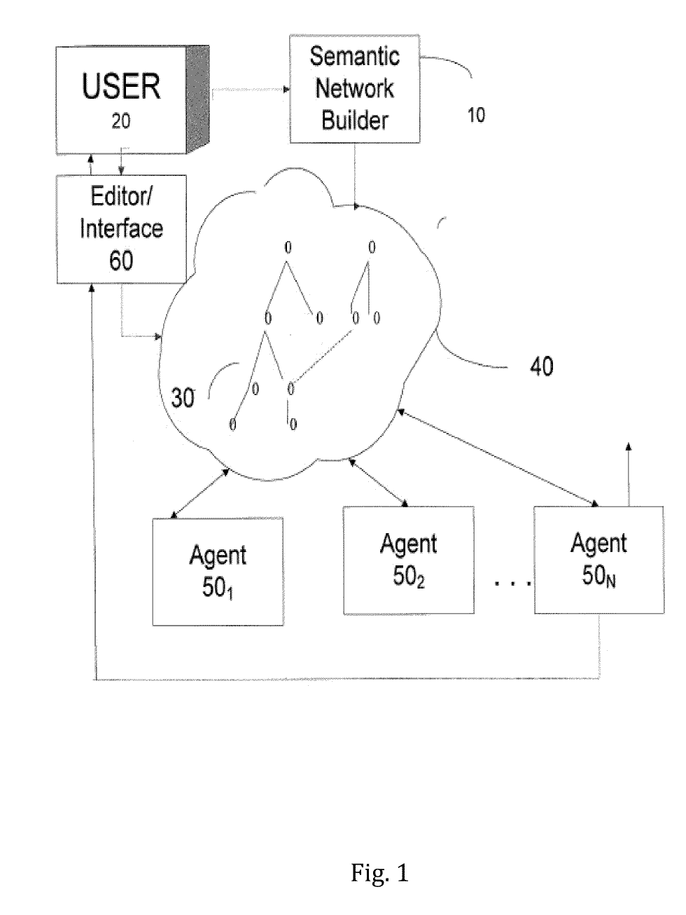

Referring to FIG. 1, illustrated are the components of a basic, exemplary system implementing some of the above-discussed aspects. A semantic network (ontology) building tool 10 is used by a user 20 to build a semantic network 30 in a computer network-accessible memory 40, which may be local, remote or distributed memory such as memory distributed across the Internet, for example. The semantic network building tool may be any computer (hardware and software) which is suitably adapted and configured (by software, for example) to generate a semantic network when a user provides the necessary inputs. Software agents 50₁-50_{N}, which may execute on computers (not shown) anywhere that have access to the semantic network, interact with the semantic network and perform their respective functions on the data in the network. As illustrated, it is presumed that at least one agent, such as 50_{N}, performs an output function and provides output to user 20. However, the results of agent interactions need not be output to the user in applications where the user merely wants tasks completed and does not require reporting on those tasks.

Once the semantic network exists, the user 20 may use an interface tool 60 to effectuate changes to the network. The interface tool may be any suitable editor which can show the semantic network to the user (e.g., in a graphical user interface) and allow the user to enter alterations to the network. Alterations may include changing data values, as well as adding entries to or deleting entries from the semantic network. Tools such as mind-mapping software or ontology-builders may be directed to these aspects of user interactions.

Note that the user(s) need not interact directly with the agents once the agents have been deployed (i.e., started). Naturally, someone has to deploy each agent, which in turn requires identifying which agents in the system will participate.

An agent may be personal to a user or an agent may be agnostic as to user identity. Thus, a shopping agent may be the personal agent of a specific user or a shopping agent may be available to any user that needs it, as an example.

The semantic network landscape in which the software agents may operate, enabling users to express themselves both by expressly editing the network and by allowing agents to deduce user intentions from combinations of actions. Agents may be plain and simple, with limited functionality. Manifestly, the user-network and agent-network interactions do not make up a direct dialogue between users and the software agents. This lack of direct dialogue is characteristic of the current system and method. People participate by constructing landscapes of their thoughts (in semantic data) while large numbers of these simple agents work over (i.e., interact with) that highly personalized landscape to get work done. Different types of agents (for example, search agents plus harvesting agents) may collaborate to accomplish tasks that, typically, no one agent type would be able to provide.

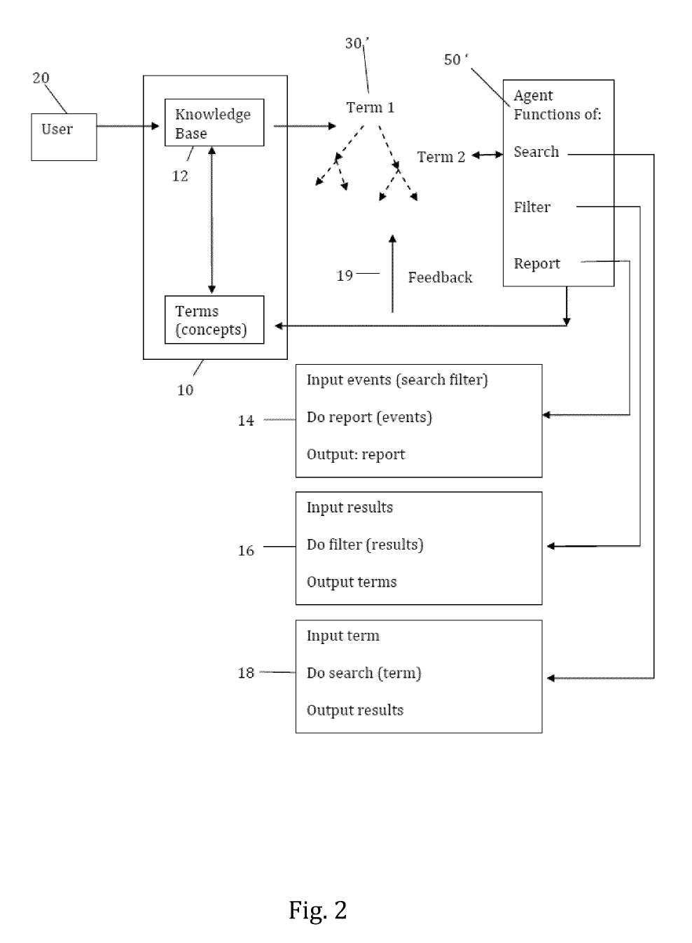

A specific example of a simple semantic network 30′ and its use herein is shown in FIG. 2. Assume a user expresses a query to a semantic network synthesis tool (also called a builder or engine) 10, having (or having access to) a knowledge base 12 appropriate to a domain of interest. One or more agents 50′ (e.g., search, filter and reporting agents) act autonomously (and independently) over the network 30′. Outcomes may be fed back to the user, as by modules 14, 16 and 18, or to the network (as indicated at 19). The modules 14, 16, and 18 may also allow a user to instruct the agents or change their conditions, parameters, functions or status. Complex knowledge then may emerge from simple interactions over the user's landscape of knowledge as expressed in the knowledge base.

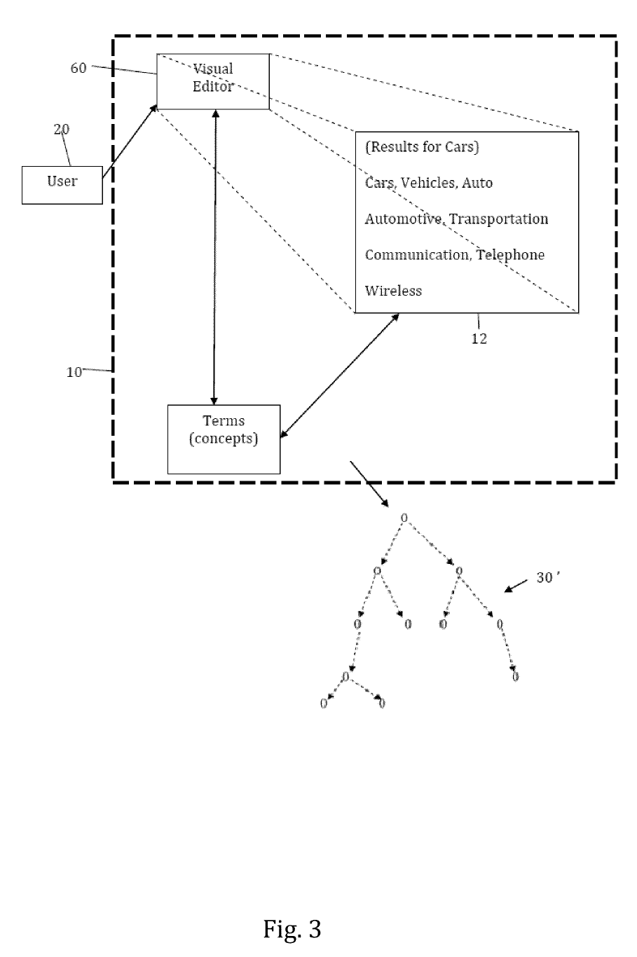

FIG. 3 illustrates that a user 20 may edit the knowledge base 12 used by a synthesis engine, also. For example, a visual editor 60 may be employed (it may be either part of the engine, as shown, or external to the engine. Thus, results may emerge from the combined actions of users and agents.

Selection of a synthesized term may allow for entity disambiguation or entity resolution, for example. Thus the term “nutrient” may mean something different to a botanist than it will to a fitness aficionado. Outcomes may be presented to a user, for example, according to an intelligent ranking. Such a ranking may be in accordance with the user's preferences that can be determined with the teachings disclosed in the reference entitled System and Method Directed Towards Preference Guided Data Exploration, which is fully incorporated by reference and a copy of which is attached as Appendix A. Further, the underlying semantic network 30′ may, based on user preferences, weight some concepts or topics more heavily than others by applying teachings as disclosed in the reference entitled System and Method of Preference Guided Data Explorations Applied to Atomic Semantics, which is fully incorporated by reference and a copy of which is attached as Appendix B. Agent functioning may then be applied to a network focused on concepts more relevant to a user. Such weighting and preferential ranking may be determined based on user-click patterns, browser history, the selection of a synthesized concept, etc. that influence the semantic network without the user's explicit editing or amendment thereof.

One scenario where the teachings disclosed herein are illustrated may be where a user is relocating his or her residence and, thus, is interested in a new location. Using traditional user-agent methods, that user would have to modify all the agents that provide location-based information such as hyper-local news for notification of nearby-events. Leveraging a user-based semantic network with harvesting, search or other type of agents instead allows the user to merely modify the knowledge base and thereby modify the semantic network to reflect the updated city, country or any other locality of interest. Each of the agents will then act upon this updated location information and more accurately serve the user, eliminating the need for the user to determine which agents require updated location information and without the user having to directly modify each of those agents with such updated location information. The agents may further act to modify the semantic network by adding related concepts to the new location of interest, such as including the new location's county, state or country in the case of an international move.

As another example, user interested in physical fitness may have harvesting agents deliver related content such as nutrition articles or training routines, or may have shopping agents notify the user of relevant gym equipment. If that user injures his shoulder, conventional approaches would require the user to modify each of those agents directly. Using the teachings disclosed herein, the user may instead edit the semantic network to reflect the new relevance to the user of rehabilitation or specific information about the shoulder, allowing agents that are tailored accordingly to deliver articles, routines and equipment of interest without direct user-agent interaction. Note that modification of the semantic network to include concepts such as rehabilitation can occur without the user's explicit incorporation of such. The user may simply enter “injury,” which the network can identify as a concept related to “rehabilitation” via use of a reference corpus. Also, merely clicking on articles associated with injury or rehabilitation may reveal a user interest in such content and result in modification of the semantic network accordingly. The network can be dynamic, changing with time so as to apply less weighting and a weaker preference towards injury or shoulder rehabilitation-related concepts. This may occur as the frequency of the user's selection of such content decreases, suggesting the recovery of the user's shoulder.

Further, traditional agents with instructions related to highly user-dependent concepts require modification. For example, selection of “heroes” may mean comic book characters to an 8-yr old child but may mean civil rights leaders to 65-yr old citizen. Religion is another example of a concept that is highly user-dependent. The concept “religion” and associated content will strongly vary from a seasoned priest to a young Buddhist. The traditional user-agent interaction requires every agent operating on the concept of religion or heroes to be identified by the user and modified to reflect the particular subjective views, experiences or interests of the user. Instead, augmenting the “religion” or “hero” concept in one's semantic network allows agents to act in accordance with the user's meaning. The result is a reduction in user-effort and agent complexity.

Agents may act in tandem and leverage information from each other. An agent that performs location-based information may do so based on content retrieved by a search agent. An article retrieved by a search agent for shoulder rehabilitation may suggest a particular type of yoga or hydro-therapy as treatment and modify the semantic network accordingly; the location-based agent may determine that treatment is relevant from the semantic network and identify facilities that perform such treatment in the region. Alternatively, a shopping agent may identify available products that can be used to perform the article's prescribed treatment.

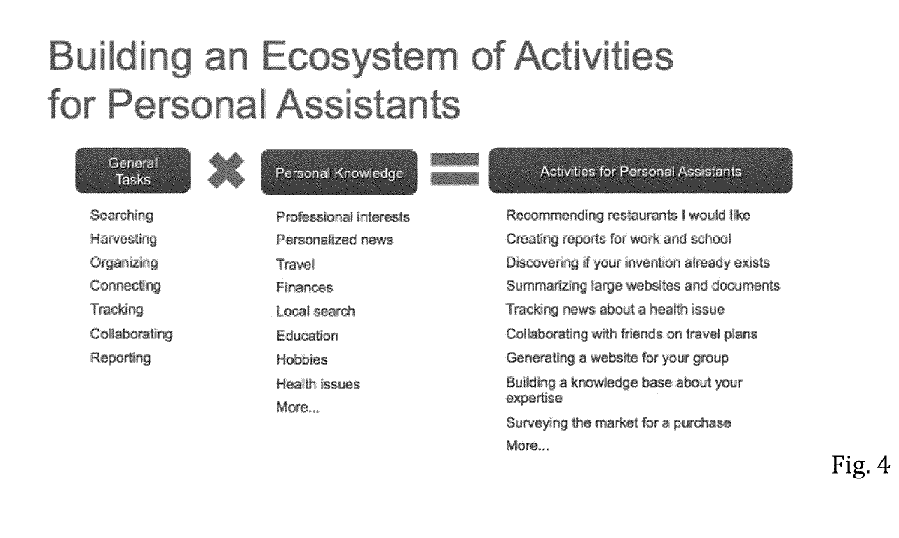

In all of the foregoing cases, employing traditional agents would require the user to modify each agent serving that person, or a complicated agent would need to be constructed to accurately serve the user and perform varying tasks. The teachings disclosed herein can integrate general tasks such as searching, harvesting, organizing, connecting, tracking, collaborating, or reporting with aspects related to personal knowledge such as professional interests, personalized news, travel, finances, local search, education, hobbies, or health issues, to serve the user in a vast number of ways, such as those listed in FIG. 4.

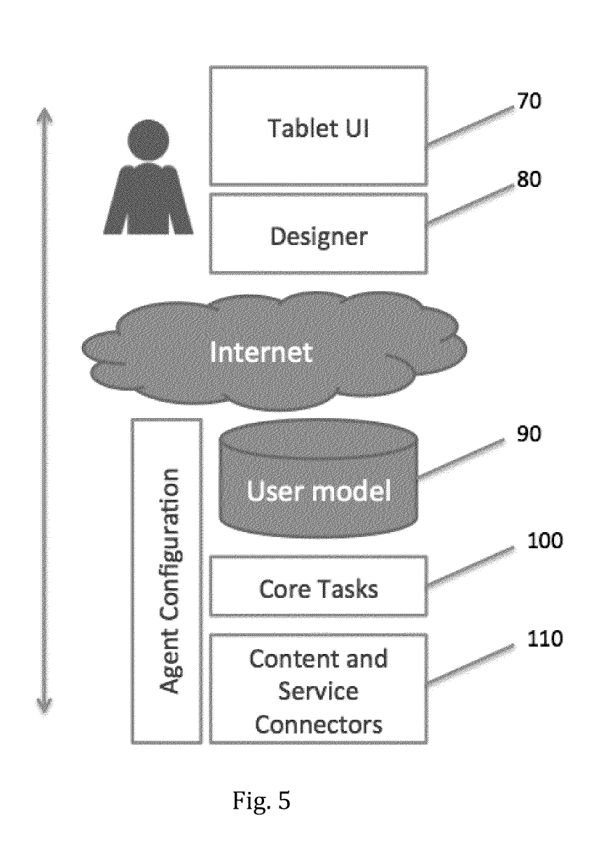

FIG. 5 provides a non-limiting example embodiment of potential system components in some implementations of an agent ecosystem as taught herein. A “harvesting” interface can be provided on, for example, a tablet computer 70. Such a user interface can utilize one or more “native” application programs provided on or for the computer (e.g., conventional operating system and browser software) to support agent tasking. For example, conventional browser software can be used to find and clip words and phrases from sites of interest and add this material to a semantic network—e.g., by adding nodes to an existing network data structure. (While the device illustrated in FIG. 5 is a tablet computer 70, any suitable computing system such as a client PC, laptop, mobile device, PDA or related computing system may be used.) A conventional application, such as a browser or a word-processing program capable of supporting graphics, may be used to display the results of the agent operations. Designer 80 is shown as an optional supplemental application software tool to demonstrate the extensibility of the agent system to allowing use of other software, as well, for agent design, network design, and updating/alteration of either of them. User model 90 indicates that the net impact of a collection of agents is to capture user-interests and intentions in such a way that the need for recursive user-interactions and querying is greatly eliminated, the agents becoming a mechanism that provides the blueprint for services the user desires.

Core agent tasks 100 operate over the internet content and services, and include the aforementioned harvesting, connecting, reporting, etc. Content/service application programming interfaces (APIs) 110 and crawlers act as interfaces to the Internet.

An individual agent, or a collection of agents (each having a dedicated function) may function, and be thought of, as a user's assistant(s). Such assistants may serve multiple users. Indeed, when appropriate to their function, the assistant also may be monetized by multiple users. For instance, consider a first user that may not be a developer but may still like to create things using technology. The first user may create an assistant using the agents framework disclosed herein. To do so, the user may launch an assistant desimer application, which performs the dual roles of designing individual agents and assembling groups of agents around specific tasks, as well as allocating resources to each type of agent. (Where allocating resources to an agent means defining those data the agent may take as inputs and supply as output.) The user typically also may be asked to specify the purpose of his or her assistant—i.e., its function.

The designer application may be set up to include certain agents in the assistant by default, by choice or both. Default agents may include, for example, a connecting agent to synthesize new connections across a domain (see below); a harvesting agent to extracts terms from retrieved content nodes, such as a relevant abstract; and a reporting agent to provide a status on the information available for a particular context (such as the identification of a new restaurant, if that is the assistant's purpose).

A “connecting agent” is simply the term used to reference an agent that can augment a concept node from a semantic network with further concepts that are identified from other domains. That is, it establishes a cross-domain connection, or bridge, a link. The connection may be one that is ascertained from a reference corpus (e.g., one or more websites, documents, etc.) or a reference semantic lexicon (e.g., graphical lexicons such as WordNet, thesauri, dictionaries, etc.; WordNet is a lexical database for the English language, created and maintained at the Cognitive Science Laboratory of Princeton University). The agent may operate by referencing the semantic network and receiving a seed concept, following which it may then augment the seed concept with semantically related terms that are of relevance from the reference corpus/lexicon. The agent may analyze the concept node by identifying terms that comprise the concept node, and analyze related domains for literal and semantically related matches.

While both a connecting agent and a harvesting agent may augment a node of the semantic network, a connecting agent does so by incorporation of a link or attachment to another node, whereas a harvesting agent will, based on one or more nodes in the semantic network, harvest information from a reference corpora and augment the one or more nodes by attaching the harvested (i.e., augmenting) information. The augmenting information to be attached by a harvesting agent is typically a finite amount of information such as typically would be characterized as a “snippet of data,” “chunk of content,” “paragraph” abstract,” etc.

Continuing with restaurant identification as an example context, using an agent designer application (software tool) or other selection mechanism, the user may select from among various pre-existing agents to include in an assistant. These may include, for example, a review collection agent whose function is to retrieve restaurant reviews from multiple sources using terms acquired from a context within an individual's semantic network; a web search agent that may search for terms from a context within an individual's semantic network and a text message mining agent that may retrieve information from messaging accessible within an individual's semantic network.

As a specific example, a restaurant agent may be configured to keep the user informed of all restaurants in the user's city that have been reviewed in some list of publications, web sites, etc. in the last six months, that serve certain types of food, and that were rated at least three stars our of five. When the agent identifies such a restaurant, it may add that restaurants to the user's semantic network at a node we may call “new restaurants to try.” A reporting agent, noting the addition of a restaurant to the network, may send a message (text, e-mail, or other service) or simply add to a “new reports” queue the user checks from time to time, the fact of the restaurant's addition to the network. The user may try the restaurant and decide she does not like it. Another agent may note that the restaurant was visited once by the user (e.g., by monitoring the user's credit card statement) and also note that a year has gone by and the user has not returned to the restaurant, resulting in the agent either automatically purging the restaurant from the user's list of restaurants she likes, or the agent may ask the user whether to retain or purge the restaurant.

These are but simple examples of the way agents may interact with a user, with a semantic network and with each other, to act as a person's assistants, relieving the person of the otherwise time-consuming tasks the agents perform.

In some embodiments, a constructed assistant may be monetized. For instance, a licensing mechanism may be set up to meter the re-use of agents, charge the re-user and credit the original designer some amount in connection with the re-use. For example, a fixed amount, such as $0.02, may be charged each time an individual tasks a specific assistant to issue a status report. This charge may be partially credited to the constructor of the assistant and partially credited to the host system supporting the agent ecosystem. In some embodiments, the amount charged may be offset or be eliminated by the use of other revenue sources, such as advertising, for example.

To facilitate the licensing and re-use of such agents, the ecosystem preferably includes an agent-naming module that allows a creator to name the agents and assistants he/she creates, and to label/designate them as publicly available (if so desired). (For example, a public register of such agents may be maintained for this purpose and a creator may then register her agent. Registration typically would involve identifying the creator, the name of the agent, its function, its inputs and outputs, and any relevant licensing terms such as the charge for using/copying/modifying the agent.) In addition to a second user being licensed to re-use an agent or assistant, a second user also may be granted permission (again, possibly for a fee), to clone and modify the assistant, such as by altering the selection of agents as deemed advantageous by the second user. For example, a second user may add a location-filtering agent to a restaurant assistant which had included only an agent that identifies restaurants by type of cuisine. In some embodiments, the second user may assign a charge per reporting task performed by the newly modified assistant and register it also to be publicly available on that basis, perhaps with the original designer sharing in the resulting revenue.

Thus it will be seen that there has been shown a new method and system for combining user-directed semantic networking with computerized agents, typically large numbers of simple agents, wherein both users and agents interact with a semantic network without users having to control agents expressly and directly.

The above-described embodiments of the present invention can be implemented in any of numerous ways. For example, the embodiments may be implemented using hardware, software or a combination thereof. When an embodiment or element of an embodiment is implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of various embodiments of the present invention comprises at least one tangible, non-transitory computer-readable storage medium (e.g., a computer memory, a floppy disk, a compact disk, and optical disk, a magnetic tape, a flash memory, circuit configurations in Field Programmable Gate Arrays or other semiconductor devices, etc.) encoded with one or more computer programs (i.e., a plurality of instructions) that, when executed on one or more computers or other processors, performs the above-discussed functions of various embodiments of the present invention and elements thereof. The computer-readable storage medium can be transportable such that the program(s) stored thereon can be loaded onto any computer resource to implement various aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention. The semantic network element of the embodiments discussed herein may comprise one or more data structures in one or more non-transitory computer-readable storage media, which may be the same or different storage media encoded with the above-noted one or more computer programs.

End-use applications may occur on a client PC, laptop, tablet, mobile device, PDA or related computing system. Further, some embodiments may leverage native applications such as web browsers or apps on any of these computing systems.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

All definitions, as defined and used herein, should be understood to control over dictionary definitions, definitions in documents incorporated by reference, and/or ordinary meanings of the defined terms.

The phraseology and terminology used herein is for the purpose of description and should not be regarded as limiting. The use of “including,” “comprising,” “having,” “containing”, “involving”, and variations thereof, is meant to encompass the items listed thereafter and additional items.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The indefinite articles “a” and “an,” as used herein, unless clearly indicated to the contrary, should be understood to mean “at least one.”

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. A system employing a semantic network, comprising:
a. in a non-transitory, computer-readable medium within a computer network, a data structure providing a semantic network;
b. a plurality of computer-implemented agents deployed within said computer network, executing on one or more processors within the computer network, and interactive with the semantic network; and
c. a user interface configured to permit a user to at least create or modify the semantic network;
d. wherein the agents are configured to read and modify the semantic network without receiving explicit instructions from a user after their initial deployment.

2. The system of claim 1, wherein modifying the semantic network includes changing, editing, altering, augmenting, adding to or deleting from the semantic network.

3. The system of claim 1, wherein the agents include at least one of a harvesting agent, data mining agent, search agent, connecting agent, personal agent or shopping agent.

4. The system of claim 1, wherein at least two of the plurality of agents collaborate with each other, explicitly or implicitly.

5. The system of claim 1, wherein the system is configured to allow at least one of the plurality of agents to be selected by the user.

6. The system of claim 1, wherein the user interface is a graphical user interface.

7. The system of claim 6, wherein the user interface further includes mind-mapping software or ontology-building software.

8. The system of claim 6, wherein the user-interface presents values for the user to change, the option to add entries or the option to delete entries.

9. The system of claim 8, wherein the values or entries are modifiable by user-selection with a cursor, mouse-pointer or keyboard.

10. The system of claim 9, wherein the option to add entries includes a synthesized concept presented to the user for adding to the semantic network.

11. The system of claim 1, wherein at least one of the agents synthesizes a concept to the semantic network.

12. The system of claim 1, wherein the semantic network includes at least two nodes that each represent a distinct concept and at least one edge that represents a semantic relationship between two distinct concepts.

13. The system of claim 12, wherein:
at least one of the concepts is weighted based on preferences of a user;
at least one of the edges is weighted based on the strength of the semantic relationship; or
at least one of the results is delivered to the user in an order based on preferences of the user.

14. The system of claim 1, wherein at least one of the agents of the plurality of agents changes a value, adds or deletes an entry in the semantic network.

15. The system of claim 14, wherein at least a second agent of the plurality of agents acts upon or in response to the changed value, addition or deletion of the entry.

16. The system of claim 1, wherein a fee is charged when a user assigns a reporting task to at least one of the agents created by another user.

17. A method comprising:
providing a semantic network in a non-transitory, computer-readable medium within a computer network;
providing a plurality of computer-implemented agents deployed within said computer network and interactive with the semantic network, the agents being configured, collectively, to read and modify the semantic network without receiving explicit instructions from a user; and
providing a user interface configured to permit a user to modify the semantic network.

18. A method to decouple user and agent actions with respect to a semantic network, comprising:
providing an information exchange platform comprising an editable semantic network instantiated in a non-transitory, computer-readable medium within a computer network;
providing a plurality of computer-implemented agents deployed within said computer network and interactive with the semantic network, the agents collectively being configured to autonomously read and modify the semantic network; and
providing a user interface configured to permit a user to at least receive reports regarding or to modify the semantic network.

19. A method comprising:
making available to users of a computer network a semantic network building tool and a plurality of computer-implemented agents deployable within said computer network and interactive with a semantic network constructed by the user with the tool, the agents collectively being configured to read and modify the semantic network without receiving explicit instructions from a user.

20. The method of claim 19, further including:
providing a user interface configured to permit a user to modify the semantic network.

21. A method comprising:
providing an on-line facility configured to permit a user to deploy a plurality of computer-implemented agents within a computer network in which a semantic network is embodied in a non-transitory, computer-readable medium, at least one agent being configured to read the semantic network and at least one agent being configured to modify the semantic network, without receiving explicit instructions from a user.

22. The method of claim 21, further including:
providing a user interface configured to permit a user to modify the semantic network.

23. The method of claim 22, wherein one or more agents communicate results to the user.

24. A method to decouple user and agent actions with respect to a semantic network, comprising:
providing an information exchange platform comprising an editable semantic network instantiated in a non-transitory, computer-readable medium within a computer network, or a tool permitting a user to create an editable semantic network instantiated in a non-transitory, computer-readable medium within a computer network; and
providing a facility configured to allow a user to deploy a plurality of computer-implemented agents within said computer network and interactive with the semantic network, the agents collectively being configured to autonomously read and modify the semantic network.

25. The method of claim 24, further including:
providing a user interface configured to permit a user to at least receive reports regarding, or to modify, the semantic network.

26. The method of claim 17, wherein at least one of said agents is configured to, selectively, augment the semantic network with a connection to another semantic network or with information from a source external to the network.

27. The method of claim 26, wherein the source external to the network is another semantic network.

28. At least one non-transitory computer-readable storage medium encoded with a plurality of computer-executable instructions that includes:
a semantic network module configured to provide a data structure that includes a semantic network;
an agent-interface module configured to allow interaction between a plurality of computer-implemented agents and the semantic network; and
a user-editing module configured to permit, through a user interface, modification of the semantic network by a user.

29. The at least one computer-readable storage medium according to claim 21, wherein the instructions, when executed, further perform outputting to data to the user, wherein said outputting is based on a function of one of the plurality of agents.

30. The method of claim 18, wherein at least one of said agents is configured to, selectively, augment the semantic network with a connection to another semantic network or with information from a source external to the network.

31. The method of claim 19, wherein at least one of said agents is configured to, selectively, augment the semantic network with a connection to another semantic network or with information from a source external to the network.

32. The method of claim 21, wherein at least one of said agents is configured to, selectively, augment the semantic network with a connection to another semantic network or with information from a source external to the network.

33. The method of claim 24, wherein at least one of said agents is configured to, selectively, augment the semantic network with a connection to another semantic network or with information from a source external to the network.
